(19) United States
(12) Patent Application Publication
(10) Pub. No.: US 2013/0238624 A1
(43) Pub. Date: Sep. 12, 2013

(54) SEARCH SYSTEM AND OPERATING METHOD THEREOF

(71) Applicant: SAMSUNG ELECTRONICS CO., LTD, Gyeonggi-do (KR)

(72) Inventors: Min-Ho Lee, Gyeonggi-do (KR); Jin-Guk Jeong, Gyeonggi-do (KR); Hyun-Chul Choi, Gyeonggi-do (KR)

(73) Assignee: SAMSUNG ELECTRONICS CO., LTD, Gyeonggi-do (KR)

(21) Appl. No.: 13/779,526

(22) Filed: Feb. 27, 2013

(30) Foreign Application Priority Data
Mar. 8, 2012 (KR) 10-2012-0024010

(51) Int. Cl. G06F 17/30

(52) U.S. Cl. CPC G06F 17/3071
USPC 707/737; 707/758

(57) ABSTRACT

A search system performs a method for conducting a search using a user device. The method includes receiving a search word through the user device. The method also includes displaying a homonym list indicating homonyms of the input search word on a display screen of the user device. The method further includes receiving a selection of one homonym item of the homonym list through the user device. The method still further includes conducting the search through an information search system using the selected homonym item as a search word.

### CROSS-REFERENCE TO RELATED APPLICATION(S) AND CLAIM OF PRIORITY

The present application is related to and claims the benefit under 35 U.S.C. §119(a) to a Korean patent application filed in the Korean Intellectual Property Office on Mar. 8, 2012, and assigned Serial No. 10-2012-0024010, the entire disclosure of which is hereby incorporated by reference.

### TECHNICAL FIELD OF THE INVENTION

The present disclosure relates generally to a method and an apparatus for operating a search system.

### BACKGROUND OF THE INVENTION

As a massive amount of information is provided in accordance with advances of information industry, search systems for retrieving a user's intended information are under development. In general, when the user inputs a search word, the search system searches for information corresponding to the search word in a variety of information and provides a result to the user. In some cases, the user of the search system changes and inputs the search word until the user's intended information is retrieved, and then repeats the search request multiple times.

Recently, various search systems are provided to relieve the user from repeatedly inputting the search word and requesting the search multiple times and to accurately retrieve the user's intended information. For example, when the user inputs the search word, a conventional search system searches for information by enhancing and combining the input search word and a recent search word which is retrieved the most, or by enhancing and combining the input search word and a recent search word of interest.

However, since such a conventional search system reflects only the recent search word and the popular search word without reflecting diversity of the user, it is hard to accurately obtain the search aim per user. Thus, the conventional search system may have to repeatedly search for the information by changing the input search word multiple times until the user's intended information is retrieved. Even when the search is repeated multiple times, the user's intended information may not be retrieved.

### SUMMARY OF THE INVENTION

To address the above-discussed deficiencies of the prior art, it is a primary aspect of the present disclosure to provide a search method and apparatus of a search system.

Another aspect of the present disclosure is to provide a method and an apparatus for determining a meaning of a search word corresponding to a user's intention by providing a homonym list of the search word in a search system.

Yet another aspect of the present disclosure is to provide a method and an apparatus for determining a search intention of a user by classifying homonyms of a search word based on a category and determining the category of the search word under user's control in a search system.

Still another aspect of the present disclosure is to provide a method and an apparatus for prioritizing homonyms and categories of a search word and arranging them based on the determined priority in a search system.

According to one aspect of the present disclosure, a method for conducting a search using a user device includes receiving a search word through the user device. The method also includes displaying a homonym list indicating homonyms of the input search word on a display screen of the user device. The method further includes receiving a selection of one homonym item of the homonym list through the user device. The method still further includes conducting the search through an information search system using the selected homonym item as a search word.

According to another aspect of the present disclosure, a method for searching for information using a search system includes retrieving homonyms of a search word received from a user device, and generating a homonym list indicating the retrieved homonyms. The method also includes sending the generated homonym list to the user device. The method further includes receiving a request to search for one homonym item of the homonym list from the user device, and retrieving the requested homonym item.

According to yet another aspect of the present disclosure, an apparatus for conducting a search using a user device includes an input unit configured to receive a search word through the user device. The apparatus also includes a display unit configured to display a homonym list indicating homonyms of the input search word on a display screen of the user device. The apparatus further includes a control unit configured to receive a selection of one homonym item of the homonym list through the user device, and control to conduct the search through an information search system using the selected homonym item as a search word.

According to still another aspect of the present disclosure, an apparatus configured to search for information in a search system includes a communication unit configured to send and receive signals to and from a user device. The apparatus also includes a control unit configured to control to retrieve homonyms of a search word received from the user device, generate a homonym list indicating the retrieved homonyms, send the generated homonym list to the user device, and after receiving a request to search for one homonym item of the homonym list from the user device, retrieve the requested homonym item.

Other aspects, advantages, and salient features of the disclosure will become apparent to those skilled yin the art from the following detailed description, which, taken in conjunction with the annexed drawings, discloses exemplary embodiments of the disclosure.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed., whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a search system according to an embodiment of the present disclosure;

FIG. 2 illustrates a user device according to an embodiment of the present disclosure;

FIG. 3 illustrates an information search system according to an embodiment of the present disclosure;

FIG. 4 illustrates signal flows of the search system according to an embodiment of the present disclosure;

FIG. 5 illustrates signal flows of the search system according to another embodiment of the present disclosure;

FIG. 6 illustrates operations of the user device according to an embodiment of the present disclosure;

FIG. 7 illustrates operations of the information search system according to an embodiment of the present disclosure;

FIG. 8 illustrates a screen configuration for providing a search result in the user device according to an embodiment of the present disclosure; and

FIG. 9 illustrates a screen configuration for providing the search result in the user device according to another embodiment of the present disclosure.

Throughout the drawings, like reference numerals will be understood to refer to like parts, components and structures.

### DETAILED DESCRIPTION OF THE INVENTION

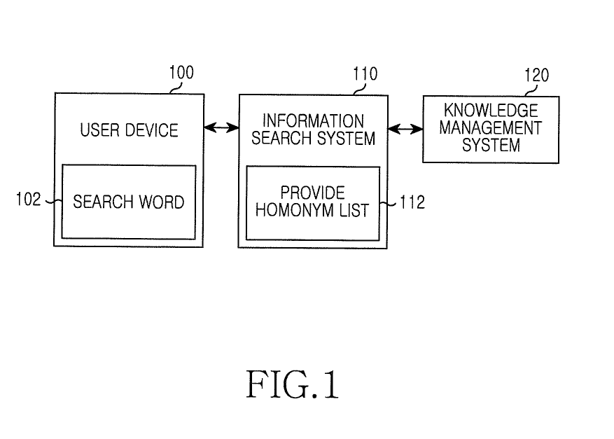

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device. The following description with reference to the accompanying drawings is provided to assist in a comprehensive understanding of exemplary embodiments of the disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of exemplary embodiments of the present disclosure is provided for illustration purposes only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present disclosure provide a method and an apparatus for determining a meaning of a search word corresponding to a user's intention by providing a homonym list of the search word, and providing a search result of the search word of the determined meaning in a search system. Hereinafter, the homonym indicates a word pronounced or spelled in the same manner but having a different meaning. To ease the understanding, the homonym of the search word is referred to as a homonymous search word, and the homonymous search word can include information indicating the corresponding meaning.

FIG. 1 illustrates a search system according to an embodiment of the present disclosure.

Referring to FIG. 1, the search system includes a user device 100, an information search system 110, and a knowledge management system 120.

The user device 100 receives a search word 102 from a user, sends the input search word to the information search system 110, and then displays a search result received from the information search system 110 in a screen to provide it to the user. In particular, the user device 100 receives a homonym list 112 including homonymous search words indicating the homonyms of the search word, from the information search system 110, displays the received homonym list in the screen, determines one homonymous search word in the homonym list under the user control, and sends the determined homonymous search word to the information search system 110. Herein, the user device 100 encompasses electronic devices for providing a search service, such as a portable terminal, mobile phone, mobile pad, media player, tablet computer, handheld computer, Personal Digital Assistant (PDA), and desktop computer.

The information search system 110 searches for the search word received from the user device 100, and then sends the search result to the user device 100. In particular, the information search system 110 retrieves the homonymous search words of the search word through the knowledge management system 120, generates the homonym list including the searched homonymous search words, and provides the homonym list to the user device 100. When receiving a signal indicating a particular homonymous search word determined from the user device 100, the information search system 110 searches for the determined search word. In so doing, the information search system 110 obtains category information of the searched homonymous search words from the knowledge management system 120 and provides a category list to the user device 100. When receiving a signal indicating a particular category determined from the user device 100, the information search system 110 may send to the user device 100 a list including only the homonymous search words corresponding to the determined category.

The information search system 110 and the user device 100 can freely access the knowledge management system 120, and the knowledge management system 120 indicates a system for providing definition and relevant information of various terms. For example, the knowledge management system 120 can be a system for providing homonym information of various terms, such as Wikipedia. The knowledge management system 120 can collect, analyze, reconstruct, and store homonyms of various terms.

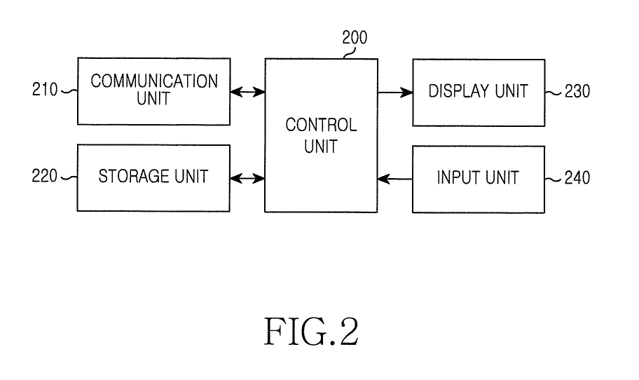

FIG. 2 is a block diagram of the user device 100 according to an embodiment of the present disclosure.

Referring to FIG. 2, the user device 100 includes a control unit 200, a communication unit 210, a storage unit 220, a display unit 230, and an input unit 240.

The control unit 200 controls and processes operations of the user device 100, and controls and processes to request to search for the user input search word and to display the search result on a screen. In particular, the control unit 200 controls and processes to send the search word input through the input unit 240 to the information search system, and to receive the homonym list from the information search system through the communication unit 210. The control unit 200 controls and processes to display the received homonym list in the display unit 230 and to determine one of the homonymous search words of the homonym list under the user control. Upon determining one homonymous search word under the user control, the control unit 200 sends the determined homonymous search word to the information search system and thus requests to search for the corresponding homonymous search word. Next, the control unit 200 controls and processes to receive the search result of the determined homonymous search word from the information search system and to display it in the display unit 230. Alternatively, the control unit 200 may receive the category list indicating the categories of the homonymous search words from the information search system, determine one category under the user control by displaying the received category list in the display unit 230, send the determined category information to the information search system, and then receive the homonym list including only the homonymous search words corresponding to the determined category.

The communication unit 210 sends and receives signals to and from the information search system under the control of the control unit 200. The communication unit 210 sends the search word and the homonymous search word to the information search system under the control of the control unit 200, receives the homonym list, the category list, and the search result of the homonymous search word from the information search system, and forwards the received information to the control unit 200.

The storage unit 220 stores various programs and data for operating the user device 100, and can store the homonym list, the category list, and the homonym search result received from the information search system.

The display unit 230 displays various status information, characters, and images generating during the operations of the user device 100, and can display the homonym list, the category list, and the homonym search result under the control of the control unit 200.

The input unit 240 includes at least one function key and a touch sensor, and provides the control unit 200 with a key pressed by the user or coordinates touched by the user. The input unit 240 receives and provides to the control unit 200 the key or the coordinates indicating the selection of one homonymous search word in the homonym list, and receives and provides to the control unit 200 the key or the coordinates indicating the selection of one category in the category list.

The method described above in relation with FIG. 2 under of the present invention may be provided as one or more instructions in one or more software modules stored in the respective user device.

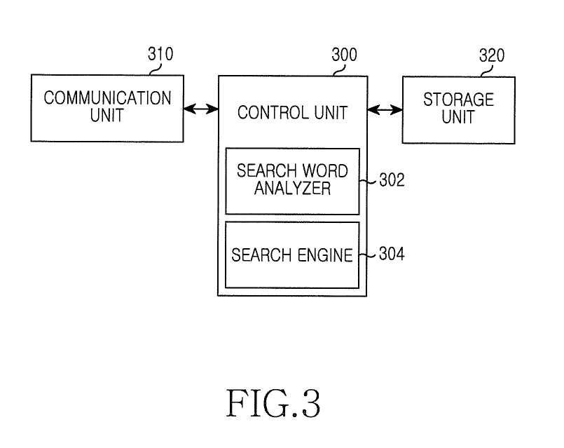

FIG. 3 is a block diagram of the information search system according to an embodiment of the present disclosure.

Referring to FIG. 3, the information search system includes a control unit 300, a communication unit 310, and a storage unit 320. In particular, the control unit 300 includes a search word analyzer 302 and a search engine 304.

The control unit 300 controls and processes the operations of the information search system. That is, upon receiving the search word from the user device 100, the control unit 300 controls to generate the homonym list of the received search word through the search word analyzer 302 and to send the generated homonym list to the user device 100. When receiving the homonymous search word from the user device 100, the control unit 300 controls and processes to search for the received homonymous search word through the search engine 304.

More specifically, when receiving the search word from the user device 100, the search word analyzer 302 controls and processes to retrieve the homonymous search words of the search word by accessing the knowledge management system, to generate the homonym list of the retrieved homonymous search words, and to provide the generated homonym list to the user device 100. In so doing, the search word analyzer 302 may obtain the category information of the searched homonymous search words from the knowledge management system, send the category list of the categories of the homonymous search words to the user device 100, and then send the list including only the homonymous search words corresponding to the determined category to the user device 100 when the signal indicating the particular category determined is received from the user device 100. Notably, as sending the category list, the search word analyzer 302 may also send the homonymous search words corresponding to the category. Herein, how to send the category list and the homonym list can be determined according to system characteristics such as network condition and system capacity, or system policy.

The search word analyzer 302 can prioritize the homonymous search words and arranges the homonym list:. In so doing, the search word analyzer 302 can prioritize the homonymous search words in various fashions. Herein, four methods of the search word analyzer 302 for prioritizing the homonymous search words are explained by way of example. However, it will be understood that the prioritization method of the present disclosure is not limited to those four methods.

According to a first method, the search word analyzer 302 can search for the related terms of the homonymous search words by accessing the knowledge management system, and prioritize the homonymous search words based on the number of the related terms. For example, provided that a data source of the knowledge management system is Wikipedia, the search word analyzer 302 can inspect pages indicating information of the homonymous search words and prioritize the homonymous search words in the descending order of hyperlinked terms in the corresponding page.

According to a second method, the search word analyzer 302 can prioritize the homonymous search words based on history information of the search word input by the user and user preference category. That is, the search word analyzer 302 can obtain search words of a particular meaning by analyzing the user's search word history information and the user preference category, and prioritize the homonymous search words based on the relation between the obtained search words and the homonymous search words. For example, when the search words of the particular meaning obtained from the user search word history information and the user preference category are a set C, the set C includes the search words C1, C2 and C3, and the homonymous search words are B1, B2, . . . , and B10, the search word analyzer 302 can establish the relation between Bi and the set C by calculating the relation between Bi and C1, Bi and C2, and B2 and C3, and prioritize the homonymous search words in the descending order of the relation. In so doing, the relation can be acquired by analyzing the hyperlink structure between the Wikipedia pages indicating the search words.

According to a third method, the search word analyzer 302 can prioritize the homonymous search words by considering the search word history information of all of users. That is, the search word analyzer 302 can count the number of the searches of the other users with respect to the homonymous search words and thus determine the priority in the descending order of the search count. The search word analyzer 302 may determine a certain number of popular search words of the great search count by considering the search word history information of all of the users, and then prioritize the homonymous search words based on the relation between the determined popular search words and the homonymous search words.

According to a fourth method, the search word analyzer 302 may prioritize the homonymous search words based on the relation between search words about recent issue and the homonymous search words.

Also, the search word analyzer 302 may arrange the category list by prioritizing the categories of the homonymous search words using the above-stated prioritization methods.

When receiving the signal indicating the particular homonymous search word determined from the user device 100, the search engine 304 searches for the determined homonymous search word, and controls and processes to send the search result to the user device 100. The search engine 304 can search for the homonymous search word using a well-known search method.

The communication unit 310 sends and receives signals to and from the user device 100 and the knowledge management system under the control of the control unit 300. The communication unit 310 receives and forwards the search word and the determined homonymous search word from the user device 100 to the control unit 300, and provides the user device 100 with the homonym list, the category list, and the search result of the determined homonymous search word under the control of the control unit 300.

The storage unit 320 stores various programs and data associated with operating the user device 100. In particular, the storage unit 320 can store the homonym list, the category list, and the homonymous search result of the search word received from the user device 100. The storage unit 320 can collect and store various information associated with operating the user device 100, such as user-based preference category information, user-based search word history information, search word search count information of all of the users, and search word information about the recent issue.

The method described above in relation with FIG. 3 under of the present invention may be provided as one or more instructions in one or more software modules stored in the respective information search system.

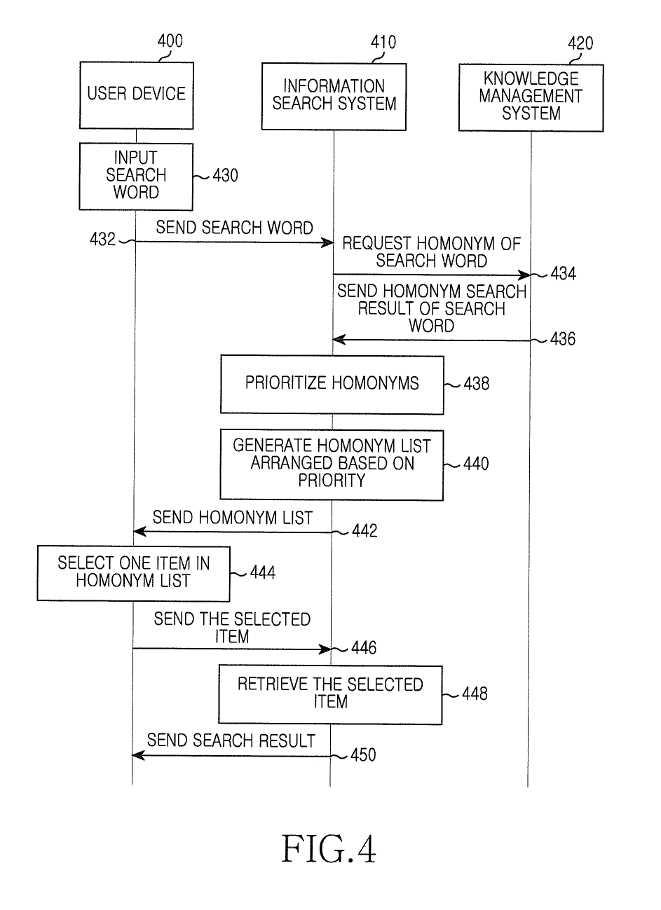

FIG. 4 depicts signal flows of the search system according to an embodiment of the present disclosure.

Referring to FIG. 4, a user device 400 receives the search word from the user in step 430, and sends the input search word to an information search system 410 in step 432.

Next, the information search system 410 requests the homonym of the search word by accessing a knowledge management system 420 in step 434, and receives the homonym search result of the search word from the knowledge management system 420 in step 436. That is, the information search system 410 receives the homonymous search words pronounced or spelled the same as the search word but having different meanings. For example, when the search word is “Hero”, “Hero” can have various meanings such as song title, film title, hero appearing in a publication, and hero appearing as a comic character. Accordingly, the homonym search result of “Hero” can include Hero of a song title of a singer A, Hero of a song title of a singer B, Hero of a song title of a singer C, Hero of a film title, Hero indicating a character in a film, Hero indicating a character in a publication, Hero indicating a character in comics D, and Hero indicating a character in comics E.

Next, the information search system 410 prioritizes the received homonymous search words in step 438, and generates the homonym list including the homonymous search words arranged based on the determined priorities in step 440. Herein, the information search system 410 can prioritize the homonymous search words in various manners as shown in FIG. 3. In step 442, the information search system 410 sends the generated homonym list to the user device 400.

The user device 400, upon receiving the homonym list from the information search system 410, selects one homonymous search word under the user control by displaying the homonym list on the screen in step 444, and sends the selected homonymous search word to the information search system 410 in step 446. When the homonym list of “Hero” includes Hero of the song title of the singer A, Hero of the song title of the singer B, Hero of the song title of the singer C, Hero of the film title, Hero indicating the character in the film, Hero indicating the character in the publication, Hero indicating the character in the comics D, and Hero indicating the character in the comics E, the user device 400 can select the item Hero meaning the character of the comics E and thus request to search for the character Hero of the comics E.

Next, the information search system 410 searches for the selected homonymous search word (e.g., using conventional well-known search methods) in step 448, and then sends the search result to the user device 400 in step 450.

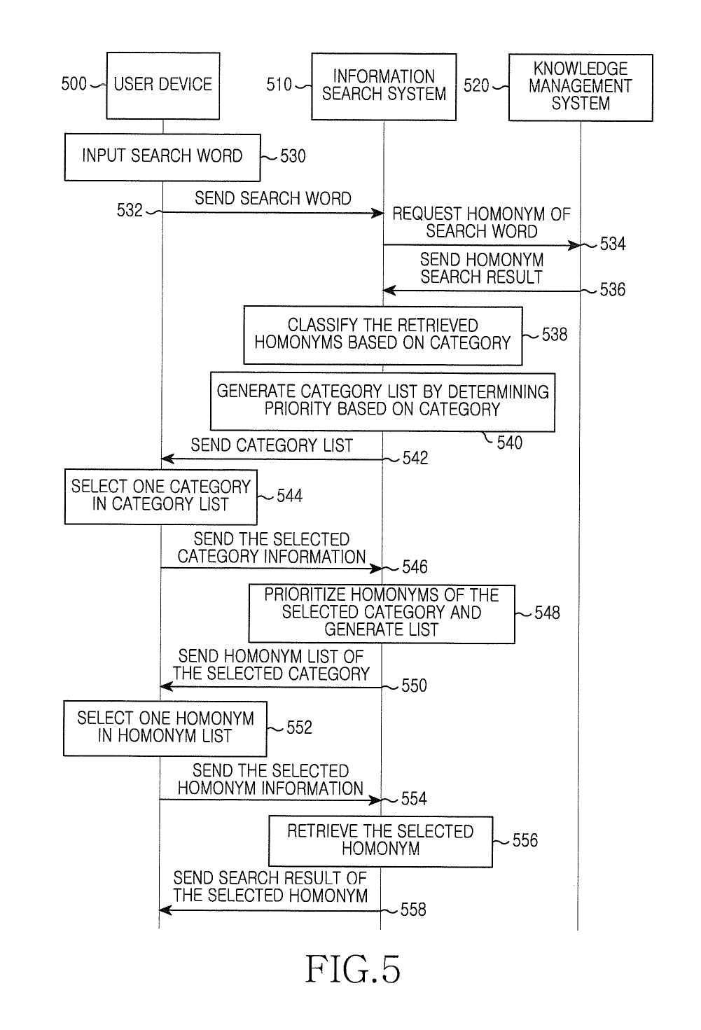

FIG. 5 depicts signal flows of the search system according to another embodiment of the present disclosure.

Referring to FIG. 5, a user device 500 receives the search word from the user in step 530, and sends the input search word to an information search system 510 in step 532.

Next, the information search system 510 requests the homonym of the search word by accessing a knowledge management system 520 in step 534, and receives the homonym search result of the search word from the knowledge management system 520 in step 536. That is, the information search system 510 receives the homonymous search words pronounced or spelled the same as the search word but having different meanings. For example, when the search word is “Hero”, “Hero” can have various meanings such as a song title, film title, hero appearing a the publication, and hero appearing as a comic character. Accordingly, the homonym search result of “Hero” can include Hero of a song title of a singer A, Hero of a song title of a singer B, Hero of a song title of a singer C, Hero of a film title, Hero indicating a character a the film, Hero indicating a character in a publication, Hero indicating a character in comics D, and Hero indicating a character in comics E.

Next, the information search system 510 classifies the searched homonymous search words based on the category in step 538, prioritizes the categories and generates the category list including the arranged categories based on the priority in step 540, and sends the generated category list to the user device 500 in step 542. In so doing, when obtaining the homonymous search words from the knowledge management system 520, the information search system 510 can generate the category list by obtaining the category information of the homonymous search words together. For example, when receiving, as the homonym search result of “Hero”, Hero of the song title of the singer A, Hero of the song title of the singer B, Hero of the song title of the singer C, Hero of the film title, Hero indicating the character in the film, Hero indicating the character in the publication, Hero indicating the character in the comics D, and Hero indicating the character in the comics E, the information search system 510 can generate the category list including the song, film, publication, and comic categories.

Upon receiving the category list of the search word from the information search system 510, the user device 500 selects one category by displaying the category list on the screen under the user control in step 544, and sends information of the selected category to the information search system 510 in step 546. For example, the user device 500 can select the song category in the category list including the song, film, publication, and comic categories under the user control, and send a signal indicating the song category selected to the information search system 510.

In step 548, the information search system 510 prioritizes the homonymous search words corresponding to the category selected by the user device 500 among the searched homonymous search words, and generates the homonym list including the homonymous search words arranged based on the determined priorities. In step 550, the information search system 510 sends the homonym list corresponding to the selected category to the user device 500. For example, when the song category is selected, the information search system 510 prioritizes Hero of the song title of the singer A, Hero of the song title of the singer B, and Hero of the song title of the singer C, corresponding to the song category among the homonymous search words of the search word “Hero”, and then selects the homonym item arranged based on the priority.

The user device 500, upon receiving the homonym list of the selected category of the search word from the information search system 510, selects one homonymous search word under the user control by displaying the homonym list of the selected category on the screen in step 552, and sends the selected homonymous search word to the information search system 510 in step 554. For example, the user device 500 can select the item Hero meaning the song title of the singer A in the homonym list corresponding to the song category under the user control, and send a signal indicating the selected item Hero meaning the song title of the singer A to the information search system 510.

Next, the information search system 510 searches for the homonymous search word selected by the user device 500 in step 556, and sends the search result of the selected homonym to the user device 500 in step 558. For example, when the user device 500 selects the item Hero meaning the song title of the singer A, the information search system 510 can retrieve the song Hero of the singer A.

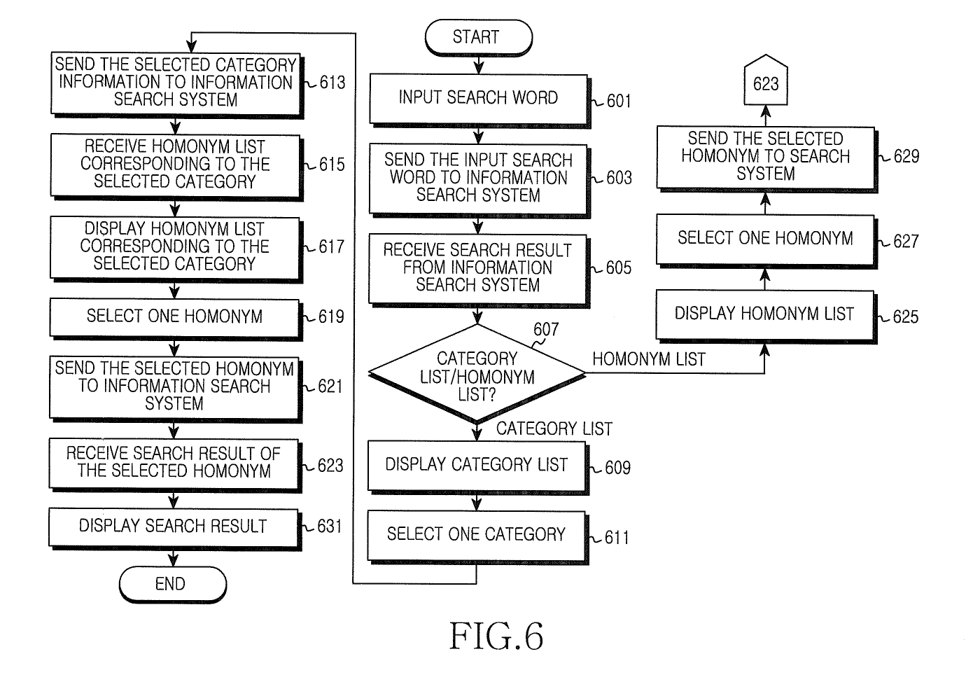

FIG. 6 illustrates operations of the user device according to an embodiment of the present disclosure.

Referring to FIG. 6, the user device receives the search word from the user in step 601, sends the input search word to the information search system in step 603, and then receives the search result from the information search system in step 605.

In step 607, the user device determines whether the search result indicates the category list or the homonym list.

When the search result indicates the category list, the user device displays the category list of the search word in step 609 and selects one category under the user control in step 611. Next, the user device sends the information indicating the selected category to the information search system in step 613, and receives the homonym list corresponding to the selected category in step 615. Next, the user device displays the homonym list corresponding to the selected category on the screen in step 617, selects one homonymous search word in the homonym list under the user control in step 619, and then sends the selected homonymous search word to the information search system in step 621. Next, the user device receives the search result of the selected homonym in step 623 and displays the received search result in step 631.

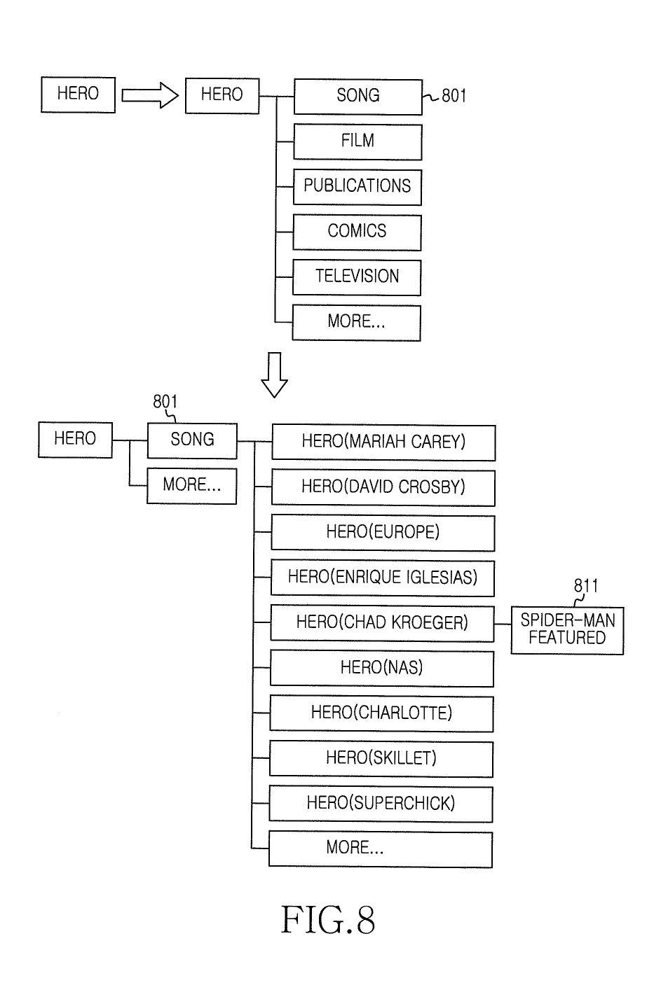

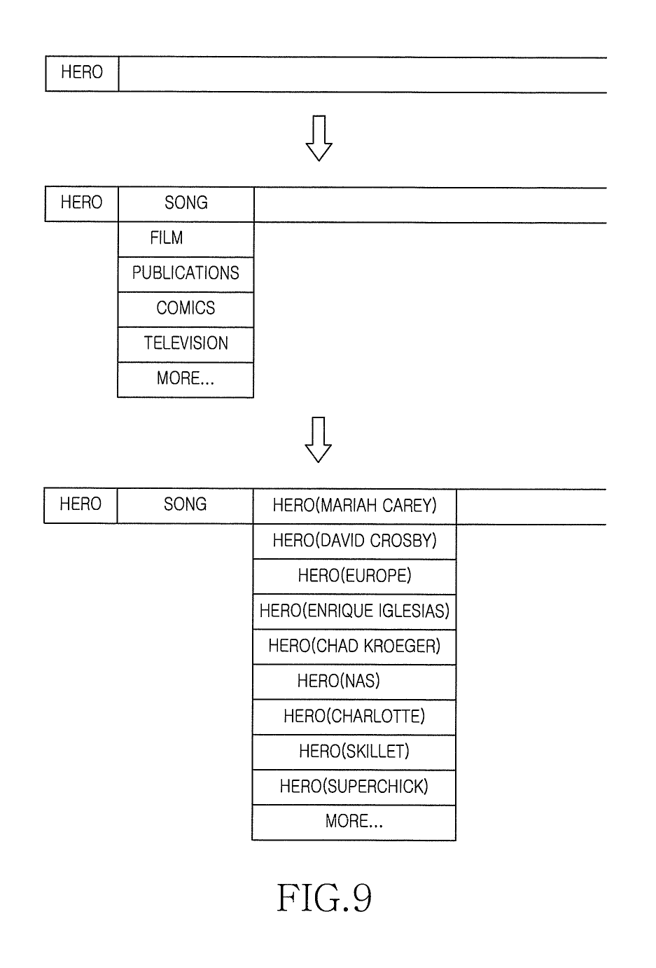

For example, as shown in FIG. 8, the user device receives and displays the category list including the song, the film, the publication, the comics, the television, and so on, on the screen in relation to the search word “Hero”. Upon detecting the song category 801 selected under the user control, the user device notifies the song category 801 selected to the information search system. Next, the user device can receive from the information search system and display on the screen, the homonym list including Hero (Mariah Carey), Hero (David Crosby), Hero (Europe), Hero (Enrique Iglesias), and Hero (Chad Kroeger) as the homonymous search words corresponding to the song category 801. In so doing, the user device can additionally display characteristic information or relevant information of the homonymous search words. For example, the user device can add information such as Spider-Man 811 to Hero (Chad Kroeger) in FIG. 8 and indicate the information relevant to the corresponding homonymous search word. Notably, the characteristic information or the relevant information of the homonymous search words should be provided from the information search system. Next, upon detecting the selected Hero (Mariah Carey) under the user control, the user device can notify the selected Hero (Mariah Carey) to the information search system and thus receive the search result of Hero of Mariah Carey from the information search system. Herein, while the user device can display the category list and the homonym list based on the category in a tree structure as shown in FIG. 8, the lists may be displayed in a drop-down menu structure as shown in FIG. 9.

Alternatively, when the search result indicates the homonym list, the user device displays the homonym list on the screen in step 625, selects one homonymous search word in the homonym list under the user control in step 627, and then sends the selected homonymous search word to the information search system in step 629. Next, the user device receives the search result of the selected homonym in step 623 and displays the received search result in step 631.

Next, the user device finishes this process.

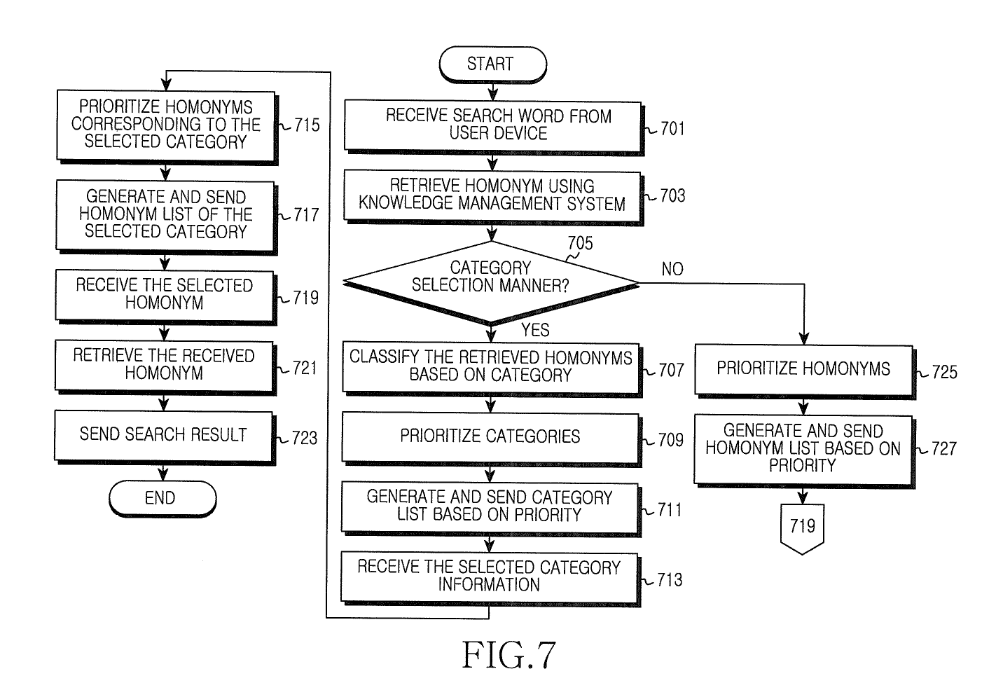

FIG. 7 illustrates operations of the information search system according to an embodiment of the present disclosure.

Referring to FIG. 7, when receiving the search word from the user device in step 701, the information search system retrieves the homonyms of the search word by accessing the knowledge management system in step 703. For example, the information search system can retrieve Hero (Mariah Carey), Hero (David Crosby), Hero (Europe), Hero (Enrique Iglesias), Hero (Chad Kroeger), . . . , Hero (1917 film), Hero (2004 film), Hero (TV channel), and Hero (2009 TV series) as the homonyms of the search word “Hero”. The homonymous search words can include information indicating the meaning of the corresponding search word “Hero”.

In step 705, the information search system determines whether its search manner is based on the category selection. That is, the information search system determines whether its search manner provides the category list of the search word to the user device and then provides the homonym list of the selected category list or provides the homonym list to the user device without the category list. In so doing, the search manner can be determined according to the system characteristics such as network condition and system capacity, or the system policy. When a particular search manner is predefined, step 705 can be omitted.

Using the search based on the category selection, the information search system classifies the retrieved homonymous search words based on the category in step 707 and prioritizes the categories in step 709. In so doing, the information search system can prioritize the categories using the prioritization method as shown in FIG. 3. In step 711, the information search system arranges the category items based on the priority, and generates and sends the category list including the arranged category items to the user device in step 711. For example, the information search system can obtain the category information of the homonymous search words of the search word “Hero”, and generate and send the category list including the category items such as song, film, publication, comics, and television, to the user device as shown in FIG. 8.

Next, the information search system receives the information indicating the selected category item from the user device in step 713, and prioritizes the homonymous search words corresponding to the selected category in step 715. In so doing, the information search system can prioritize the homonymous search words using the prioritization method of FIG. 3. In step 717, the information search system arranges the homonymous search words of the selected category based on the priority, and generates and sends the homonym list including them to the user device. For example, upon receiving the signal notifying the selected song category 801 from the user device, the information search system confirms the homonymous search words of Hero (Mariah Carey), Hero (David Crosby), Hero (Europe), Hero (Enrique Iglesias), and Hero (Chad Kroeger) correspond to the song category 801 as shown in FIG. 8, and generates and sends the confirmed homonym list to the user device.

Next, when receiving the information indicating the selected homonymous search word from the user device in step 719, the information search system retrieves the received homonymous search word in step 721, sends the search result to the user device in step 723, and then finishes this process. For example, upon receiving the signal notifying the selected Hero (Mariah Carey) from the user device, the information search system retrieves Hero of Mariah Carey and sends the search result to the user device.

Alternatively, when not using the search based on the category selection, the information search system prioritizes the retrieved homonymous search words in step 725. In so doing, the information search system can prioritize the retrieved homonymous search words using the prioritization method of FIG. 3. In step 727, the information search system arranges the homonymous search words based on the determined priority, and generates and sends the homonym list including the arranged homonymous search words to the user device. For example, the information search system can arrange the homonymous search words Hero (Mariah Carey), Hero (David Crosby), Hero (Europe), Hero (Enrique Iglesias), Hero (Chad Kroeger), . . . , Hero (1917 film), Hero (2004 Mat), Hero (TV channel), and Hero (2009 TV series) of the search word “Hero” based on the priority, and then generate the homonym list including the search words.

When receiving the information indicating the selected homonymous search word from the user device in step 719, the information search system retrieves the received homonymous search word in step 721, sends the search result to the user device in step 723, and then finishes this process.

In this embodiment of the present disclosure, using the search based on the category selection, the information search system provides the category list to the user device and then the user device provides the homonym list corresponding to the selected category. The information search system may provide the category list and the category-based homonym list to the user device at the same time.

In this embodiment of the present disclosure, while the information search system includes both of the search word analyzer and the search engine, the search word analyzer and the search engine can be configured as separate systems according to their design. While the information search system and the user device are separated in this embodiment of the present disclosure, the information search system may be included to the user device according to the design.

As set forth above, the present search system provides the homonym list of the search word, determines the meaning of the search word corresponding to the user intention, and retrieves the search word of the determined meaning. Thus, it is possible to provide an accurate search result corresponding to the user intention and to reduce the repeated searches by changing the search word. Also, while the conventional search system provides the complicated search result corresponding to various homonyms, the present search system filters the homonym in advance and thus provides a more simplified and precise search result.

The methods as described in the claims and/or the specification of the present disclosure can be implemented using hardware, software, or a combination of them.

As for the software, a computer-readable storage medium containing one or more programs (software modules) can be provided. One or more programs stored to the computer-readable storage medium are configured for execution of one or more processors of an electronic device. One or more programs include instructions making the electronic device execute the methods according to the exemplary embodiments as described in the claims and/or the specification of the present disclosure.

Such programs (software module, software) can be stored to random access memory, non-volatile memory including flash memory, Read Only Memory (ROM), Electrically Erasable Programmable ROM (EEPROM), magnetic disc storage device, Compact Disc (CD)-ROM, Digital Versatile Discs (DVDs) or other optical storage devices, and magnetic cassette. Alternatively, the programs can be stored to a memory combining part or all of those recording media. A plurality of memories may be equipped.

The programs can be stored to an attachable storage device of the electronic device accessible via a communication network such as Internet, Intranet, Local Area Network (LAN), Wireless LAN (WLAN), or Storage Area Network (SAN), or a communication' network by combining these networks. The storage device can access the electronic device through an external port.

A separate storage device in the communication network can access a portable electronic device.

While the disclosure has been shown and described with reference to certain exemplary embodiments thereof, it will be understood by those skilled in the art that various changes in form and details may be made therein without departing from the spirit and scope of the disclosure as defined by the appended claims and their equivalents.

What is claimed is:

1. A method for conducting a search using a user device, comprising:
receiving a search word through the user device;
displaying a homonym list indicating homonyms of the input search word on a display screen of the user device;
receiving a selection of one homonym item of the homonym list through the user device; and
conducting the search through an information search system using the selected homonym item as a search word.

2. The method of claim 2, further comprising:
sending, the input search word to the information search system; and
receiving the homonym list indicating the homonyms of the search word from the information search system.

3. The method of claim 1, wherein the displaying of the homonym list on the display screen of the user device comprises:
after receiving the search word, displaying a category list of the search word on the display screen of the user device;
receiving a selection of one category item of the category list through the user device; and
displaying a homonym list indicating only homonyms corresponding to the selected category item among the homonyms of the search word, on the display screen of the user device.

4. The method of claim 3, further comprising:
sending the input search word to the information search system;
receiving the category list of the search word from the information search system;
after receiving the selection of the one category item, sending information of the selected category item to the information search system; and
receiving the homonym list indicating only the homonyms corresponding to the selected category item among the homonyms of the search word, from the information search system.

5. The method of claim 3, further comprising:
sending the input search word to the information search system; and
receiving the category list of the search word and a category-based homonym list from the information search system.

6. A method for searching for information using a search system, comprising:
retrieving homonyms of a search word received from a user device;
generating a homonym list indicating the retrieved homonyms;
sending the generated homonym list to the user device;
receiving a request to search for one homonym item of the homonym list from the user device; and
retrieving the requested homonym item.

7. The method of claim 6, wherein the sending of the homonym list to the user device comprises:
generating a category list by analyzing a category of the retrieved homonyms;
sending the generated category list to the user device;
receiving information of one category item from the user device; and
sending a homonym list indicating only homonyms corresponding to the category item among the retrieved homonyms, to the user device.

8. The method of claim 6, wherein the sending of the homonym list to the user device comprises:
generating a category list by analyzing a category of the retrieved homonyms; and
sending the generated category list and a category-based homonym list.

9. The method of claim 6, wherein the generating of the homonym list indicating the retrieved homonyms comprises:
prioritizing the retrieved homonyms;
arranging the homonyms based on the priority; and
generating a homonym list comprising the arranged homonyms,
wherein the priority is determined based on at least one of the number of terms relating to the corresponding homonym, history information of the search word of the corresponding user device, preference category information of the corresponding user device, history information of the search word of every user device, and an issue search word.

10. The method of claim 7, wherein the generating of the category list comprises:
prioritizing the category items;
arranging the category items based on the priority; and
generating a category list comprising the arranged category items.

11. An electronic device for conducting a search, comprising:
an input unit configured to receive a search word through the user device;
a display unit configured to display a homonym list indicating homonyms of the input search word on a display screen of the user device; and
a control unit configured to receive a selection of one homonym item of the homonym list through the user device, and control to conduct the search through an information search system using the selected homonym item as a search word.

12. The device of claim 11, further comprising:
a communication unit configured to send the input search word to the information search system, and receive the homonym list indicating the homonyms of the search word from the information search system.

13. The device of claim 11, wherein the control unit is configured to, after receiving the search word, control to display a category list of the search word on the display unit, receive a selection of one category item of the category list through the input unit, and control to display a homonym list indicating only homonyms corresponding to the selected category item among the homonyms of the search word, on the display unit.

14. The device of claim 13, wherein the communication unit is configured to send the input search word to the information search system under control of the control unit, receive the category list of the search word from the information search system, receive the selection of the one category item through the input unit, send information of the selected category item to the information search system, and receive the homonym list indicating only the homonyms corresponding to the selected category item among the homonyms of the search word, from the information search system,

15. The device of claim 13, wherein the communication unit is configured to send the input search word to the information search system under the control of the control unit and receive the category list of the search word and a category-based homonym list from the information search system.

16. An electronic device configured to search for information in a search system, comprising:
a communication unit configured to send and receive signals to and from a user device; and
a control unit configured to control to retrieve homonyms of a search word received from the user device, generate a homonym list indicating the retrieved homonyms, send the generated homonym list to the user device, and after receiving a request to search for one homonym item of the homonym list from the user device, retrieve the requested homonym item.

17. The device of claim 16, wherein the control unit is configured to control to generate a category list by analyzing a category of the retrieved homonyms, send the generated category list to the user device, and when receiving information of one category item from the user device, send a homonym list indicating only homonyms corresponding to the category item among the retrieved homonyms, to the user device.

18. The device of claim 16, wherein the control unit is configured to control to generate a category list by analyzing a category of the retrieved homonyms, and send the generated category list and a category-based homonym list.

19. The device of claim 16, wherein the control unit is configured to control to prioritize the retrieved homonyms, arrange the homonyms based on the priority, and generate a homonym list comprising the arranged homonyms,
wherein the priority is determined based on at least one of the number of terms relating to the corresponding homonym, history information of the search word of the corresponding user device, preference category information of the corresponding user device, history information of the search word of every user device, and an issue search word.

20. The device of claim 17, wherein the control unit is configured to control to prioritize the category items, arrange the category items based on the priority, and generate a category list comprising the arranged category items.
